(19) United States
(12) Patent Application Publication
(10) Pub. No.: US 2008/0021608 A1
(43) Pub. Date: Jan. 24, 2008

(54) Method And Device For Driver Assistance

(75) Inventor: Carsten Schmitz, Wasserburg (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/664,378

(22) PCT Filed: Aug. 26, 2005
(86) PCT No.: PCT/EP05/54212

§ 371 Date: Mar. 30, 2007

(30) Foreign Application Priority Data
Oct. 1, 2004 (DE) 10 2004 048 011.7

(51) Int. Cl. G06F 7/00

(52) U.S. Cl. 701/36

(57) ABSTRACT

A method and a device for driver assistance are described, a warning signal being output as a function of the driver status and the lane change intention in the event of a lane change.

### FIELD OF THE INVENTION

The present invention relates to a method and a device for driver assistance.

### BACKGROUND INFORMATION

There are various methods and devices of this type, which are referred to as driver assistance systems. An example of such a driver assistance system is a lane departure warning, which warns the driver in the event of departure from the lane or imminent departure from the lane. An example of such a lane departure warning is discussed in European Patent Document No. EP 1 074 430 A1. It is checked in this case whether the vehicle is departing or threatens to depart from the lane, which is delimited by roadway edge markings, for example. If so, the driver is warned.

### SUMMARY OF THE INVENTION

The connection of a driver intention detector and a driver status detector in connection with driver assistance systems, in particular in connection with a lane departure warning, elevates the functionality and acceptance of such driver assistance systems. In particular, unnecessary warnings are thus avoided as much as possible. Expansion of the functionality of the lane departure warning and improvement of its alarm rate are connected thereto.

Through suitable parameterization of the modules for lane change intention detection and for driver status detection, further optimization of the system behavior is achieved by defining suitable interfaces between the two modules.

Further advantages result from the description of exemplary embodiments and from the dependent patent claims.

### BRIEF DESCRIPTION OF THE DRAWINGS

FIG. 1 shows an overview of a processing unit in which the lane change detection and the driver status detection are performed. The processing unit is shown for the example of a lane departure warning.

FIG. 2 shows a flow chart, which represents the basic procedure for lane change classification in connection with the lane departure warning.

FIG. 3 shows a modular construction of the processing unit for the example of a lane departure warning equipped with a lane change intention detector and a driver status detector.

FIG. 4 shows an interface between a module of the lane change intention detector and a module for driver status detection, via which predefined signals are exchanged.

### DETAILED DESCRIPTION

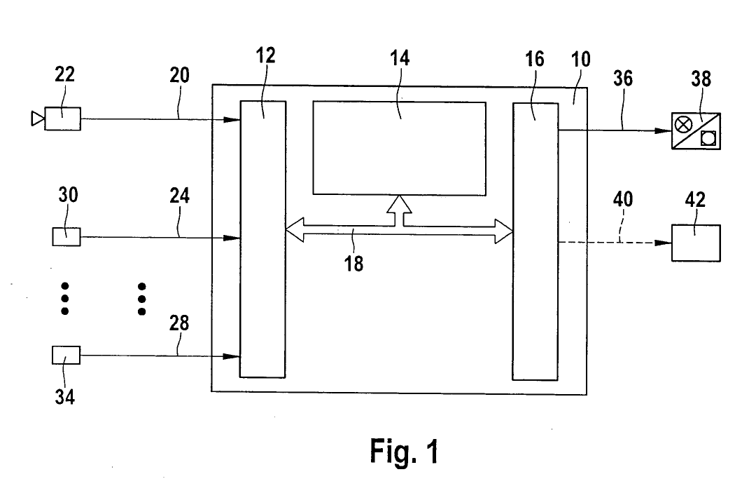

FIG. 1 shows a device which is part of a system for driver assistance (e.g., for warning and/or for activating an actuator for transversely guiding the vehicle in the event of departure or imminent departure from the lane). A control and/or analysis unit 10 is shown, which has at least one input circuit 12, a microcomputer 14, and an output circuit 16. These elements are connected to a bus system 18 for mutual data exchange. Input lines from various measuring units are supplied to input circuit 12, via which measured signals and/or measured information are transmitted. A first input line 20 connects input circuit 12 to an image sensor system 22, which records the scene in front of the vehicle. Corresponding image data is transmitted via input line 20.

Furthermore, input lines 24 through 28 are provided, which connect input circuit 12 to measuring units 30 through 34. These measuring units are, for example, measuring units for measuring the vehicle velocity, for detecting the steering angle and/or the yaw rate, for detecting a variable which represents an acceleration intent of the driver, such as the extent of the accelerator pedal actuation by the driver, for detecting the velocity and/or the acceleration of the vehicle, and for detecting further operating variables of the vehicle which are significant in connection with the procedure described in the following. At least one warning unit 38 is activated via output circuit 16 and output line 36, such as a warning lamp and/or a loudspeaker for an acoustic warning and/or for a speech output and/or a display for displaying an image and/or an actuator for a haptic indicator, with the aid of which the driver is informed about the (imminent) departure from the lane. In addition or alternatively thereto, in some exemplary embodiments, an actuator system 42 is activated via output circuit 16 and an output line 40, which automatically returns the vehicle back into the lane by intervening in the steering of the vehicle, for example, (lateral steering) and thus prevents the departure from the lane.

Using methods of image analysis, in the exemplary embodiment of the lane departure warning, lane data is ascertained on the basis of the image data of the scene in front of the vehicle supplied by the image sensor system, which represents the course and the size of the lane. Thus, for example, the lane edge markings (left and/or right lane edge) are detected and the course of the particular lane edge is approximated as a polynomial (third-order power function), for example. Furthermore, the course of the track of the vehicle, for example, for the right and/or left wheel, is calculated from vehicle geometry variables, the current and possibly preceding variables (magnitudes) of the vehicle velocity, the steering angle or the yaw rate, etc., and also represented as a polynomial. Further lane (track) data is calculated from the cited data, such as the lateral distance between the lane marking and the track of the vehicle (right side to the right edge, left side to the left edge), the curvature of the track, and/or the angle between the track and the lane marking (right lane to right edge, left lane to left edge) on the basis of tangent comparisons. In one embodiment, the expected time to line crossing is also possibly calculated therefrom. The warning occurs in an exemplary embodiment upon exceeding a predefined lateral distance or upon falling below a predefined time value.

It is essential for such a function that the driver is only warned when he actually does not intend to drive over the lane marking.

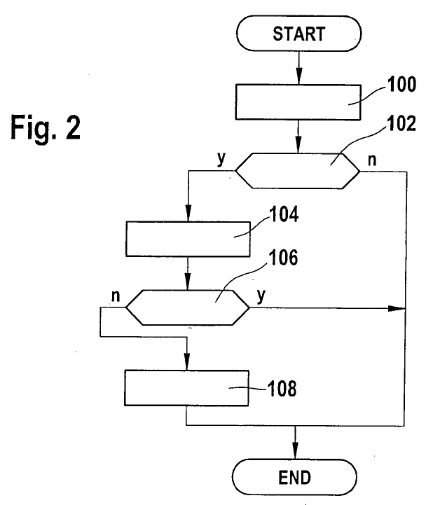

FIG. 2 shows a flow chart in which the described lane departure warning is supplemented by a classifier which analyzes the lane change situation on the basis of operating variables of the driver and classifies it into “unintentional lane change” or “intentional lane change.” The flow chart of FIG. 2 outlines a corresponding program, which is run in the microcomputer of the device shown in FIG. 1 at predetermined time intervals. In first step 100, the above-mentioned lane data is input (once for one vehicle side, in another pass for the other vehicle side), i.e., the course of the lane edge marking, the course of the actual lane of the vehicle, a variable for the lateral distance between vehicle and lane edge, a variable for the angle between vehicle lane and lane edge, and/or the further above-mentioned operating variables, etc. In following step 102, it is checked whether there is a departure from the lane or such a departure is imminent. If not, the program is continued at the next instant at step 100.

If a departure or an imminent departure is recognized, it is ascertained by the classifier on the basis of operating variables in step 104 whether the lane change is intentional or unintentional. It is then checked in step 106 whether the departure from the lane is intentional or not. If it is intentional, the warning and/or the lateral steering reaction is not performed and the program is repeated at step 100. However, if it has been recognized that the departure from the lane is unintentional, a visual, acoustic, and/or haptic warning is given and/or a lane retention reaction, such as the activation of an actuator to influence the steering, is executed according to step 108.

Different embodiments for classification are known. The basic procedure for classification is based on the analysis of at least two operating variables of the vehicle, on the basis of which the behavior of the driver may be concluded. Operating variables which are suitable for this purpose are, for example, the steering angle (alternatively the yaw rate), the velocity of the vehicle and/or the acceleration or deceleration, the lateral offset between the vehicle lane and the lane edge, in particular its change, and/or the angle of the vehicle lane to the roadway edge. The steering behavior, which is clearly recognizable in the event of an intention to change lanes, is checked in relation to the steering angle. A steering angle greater than a predetermined value, in particular a corresponding chronological change of the steering angle, indicates an intention to change lanes. During cornering, the roadway curvature ascertained is to be taken into consideration for this purpose. Furthermore, in the event of an intention to change lanes, in particular to the left, there is usually an acceleration of the vehicle, so that in the event of an acceleration of the vehicle and/or an acceleration intent of the driver greater than a predefined threshold value, an intentional lane change is to be assumed. A further suitable variable is the lateral distance of the vehicle to the lane marking, in particular its chronological change. This represents a measure for the severity with which a vehicle approaches the lane edge marking. This measure is significantly greater in the event of intended lane changes than in the event of unintended lane changes. This applies correspondingly for the angle to the lane marking, which is significantly greater in the event of intended lane changes than in the event of unintended lane changes.

In summary, it may be stated that classification of the lane change procedure into unintended and intended lane changes is performed on the basis of operating variables of the vehicle, in particular if the steering angle exceeds a threshold value and/or the acceleration intent of the driver exceeds a threshold value and/or the time curve of the lateral distance to the edge marking exceeds a threshold value and/or the angle to the edge marking exceeds a threshold value. These criteria are used in weighted form for classification of the lane change procedure into intentional and unintentional lane changes, an intentional lane change generally being recognized if at least one of the situations described exists, and an unintentional lane change being recognized if none exists.

Multiple approaches in regard to the driver status detection have also been described in the related art. For example, DE 100 39 795 A1 discloses deriving the driver status or a signal representing the attentiveness of the driver from whether a device situated in the vehicle is being used. A further criterion may be the observation of the driver by a camera and analysis of the viewing direction, the eye-blinking frequency, and/or the head position of the driver. Furthermore, sensors have been described which ascertain a tiredness status of the driver, for example, via a measurement of the body temperature and/or the pulse frequency. A signal representing the driver status is ascertained from these variables, criteria known from the related art being applied, for example.

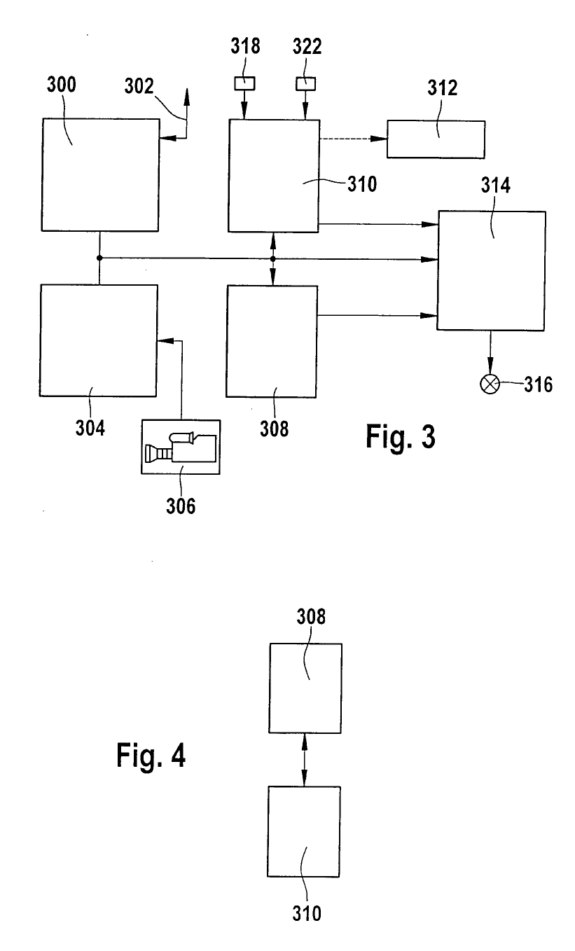

FIG. 3 shows an exemplary embodiment of the construction of the processing unit from different modules, which are essentially implemented as software modules. A first module 300 is connected to an internal vehicle bus system 302, such as a CAN bus system. Various operating variables of the vehicle are supplied to the processing unit via the bus system, such as steering angle, accelerator pedal position, brake actuation, yaw rate, etc. The variables supplied are relayed to other modules of the processing unit, possibly preprocessed, which analyze the corresponding variables.

A second module 304 includes an algorithm for lane recognition. Data which represents the image of a camera 306 that records the scene in front of the vehicle is supplied to this algorithm. The lane recognition algorithm ascertains variables from the camera image as described above, such as the lateral distance of the vehicle to the edge markings, the angle of the vehicle to the edge markings, and the curvature of the lane. The variables ascertained are supplied to other modules of the processing unit as described in the following.

In another embodiment, alternatively or additionally to the variables ascertained (lane data), information is transmitted which indicates a lane change or an approaching lane change. This is ascertained as noted above on the basis of the value of the lateral distance and/or the time to line crossing, for example.

A further module is module 308 for lane change intention detection. This module includes the algorithms which decide whether a lane change is performed intentionally or unintentionally. A procedure for implementation is described above. For this purpose, the necessary operating variables are supplied to module 308. These operating variables are supplied via the internal vehicle bus, such as the steering angle or yaw rate, vehicle velocity, acceleration, and/or are provided by the lane detection algorithm (module 304), such as the lateral distance to the roadway edge marking, its change, and/or the angle to the roadway edge. In a known way, module 308 ascertains information on the basis of these operating variables as to whether the lane change is intentional or unintentional. This information is also evaluated as described in the following with the result of the driver status detection.

The latter occurs in module 310, to which the variables analyzed for the driver status detection are also supplied from corresponding detection devices 318 through 322. These variables are, as noted above, information in regard to the operation of devices, physiological information such as eye-blinking frequency, body posture information, etc., for example. Module 310 ascertains a degree of attentiveness of the driver (the vigilance of the driver) on the basis of this information, which is indicated to the driver via an information element 312, such as a scale, in an exemplary embodiment.

Furthermore, a module 314 is provided which includes the warning algorithm. The information supplied to the module (lane data or lane change signal from module 304, driver intention detection from module 308, and driver status from module 310) is supplied to this module. Module 314 possibly derives a warning which is displayed to the driver via warning element 316 from the lane data and/or the lane change data, taking the information on the lane change intention and the driver status into consideration. Depending on the embodiment, the warning element includes actuators for visually, acoustically, and/or haptically warning the driver. Module 314 produces a warning signal if there is an unintentional lane change and/or greatly reduced vigilance of the driver.

Furthermore, information is exchanged between module 310 for driver status detection and module 308 for lane change intention detection and measures are engaged in the particular module as a function of the exchanged information. The interface between the two modules is defined in such a way that information in regard to the vigilance of the driver (driver status) is transmitted from module 310 to module 308, while information in regard to the lane change intention is transmitted from module 308 to module 310.

In the exemplary embodiment, a variable which represents the frequency of unintentional lane crossings, which may be per unit of time, is transmitted.

As a supplement to or instead of the information in regard to the frequency of unintentional lane departures, the frequency at which at least one threshold is unintentionally exceeded, in particular a threshold in regard to the lateral distance to the lane boundary and/or falling below a threshold value for the “time to line crossing” value, is transmitted from module 308 to module 310.

FIG. 4 shows an example of the parameterization of the two modules described above. The signals described above are exchanged in this case. The following conclusions are reached in the individual modules.

On the basis of the information obtained from module 310 about the vigilance of the driver or the driver status, the function of the lane change intention detection is turned off. In particular, in the event of poor driver status (greatly reduced vigilance), an unintentional lane change is basically assumed, so that module 314 warns in the event of each lane change. In this case, module 308 transmits the information of an unintentional lane change as the default value to module 314. In another embodiment, the warning threshold of the lane change intention detector is adaptively modified. In the exemplary embodiment, the thresholds used for lane change intention detection are reduced in order to influence the frequency of warnings.

In an exemplary embodiment, the lane change intention detector receives different input signals (e.g., steering wheel, gas pedal position). These inputs are weighted. The weighted input values are examined to see if they exceed a specific threshold (the threshold is a real number at the unit interval [0.1], typically 0.5); if it exceeds this threshold, driver intention is concluded. Thus, if the input signal (weighted) is greater than 0.5, there is driver intention, if it is less than or equal to 0.5, there is an unintentional lane departure. If this threshold is increased (e.g., to 0.9), the number of warnings of the entire system increases; at a lower threshold (e.g., 0.1), the number of warnings of the system may be reduced. (Note: at 0.0, there are never any warnings, at 1.0 there is a warning upon each lane departure). This procedure is implemented in an exemplary embodiment to influence the frequency of the warnings.

If greatly reduced vigilance is detected, the threshold of the intention detection is thus successively increased in order to obtain more frequent warnings.

In the event of an alert driver (high vigilance) a reduced warning frequency is assumed, i.e., the criteria above which an unintentional lane change exists are increased. In the event of a sleepy driver (reduced vigilance), the threshold of the warning frequency is increased, so that the driver is warned more frequently. In the exemplary embodiment, this is performed by reducing the criteria responsible for an unintentional lane change. If greatly reduced vigilance is established, the lane change intention detector is turned off as described above.

As noted above, module 310 receives information from module 308 in regard to the lane change intention and/or the unintentional lane change. In particular, values are transmitted which transmit the frequency of the unintentional lane change within a predefined period of time or the occurrence of falling below different threshold values, such as the lateral distance to the lane boundary or the time until reaching the edge marking, etc. Module 310 analyzes this information in such a way that in the event of increasing frequency of unintentionally exceeding the at least one threshold or an increase in the frequency of unintentional lane changes, the driver status is changed in the direction of being worse, i.e., the vigilance value of the driver is reduced.

1-9. (canceled)

10. A method for driver assistance, the method comprising:
outputting a warning signal in the event of a lane change, wherein the output of the warning signal is a function of a lane change intention and a driver status.

11. The method of claim 10, wherein the warning signal is produced in the event of an unintentional lane change.

12. The method of claim 10, wherein the warning signal is output in the event of one of a poorer driver status and a reduced driver vigilance.

13. The method of claim 10, wherein the warning signal is output in the event of a reduced vigilance of the driver, irrespective of whether there is an intentional or an unintentional lane change.

14. The method of claim 10, wherein the driver status is determined as a function of information as to a frequency of lane change and a type of lane change.

15. The method of claim 10, wherein the driver status is determined as a function of the frequency of at least one of unintentional lane changes and unintentionally exceeding at least one threshold value of at least one variable.

16. The method of claim 15, wherein the frequency at which the warning signal is produced is reduced in the event of high vigilance of the driver, is raised in the event of the driver having reduced vigilance, and occurs in each lane change in the event of a substantially reduced vigilance of the driver.

17. A device for driver assistance, comprising:
a processing unit which outputs a warning signal when there is a lane change, wherein the processing unit provides that a lane change intention and a driver status are taken into consideration when the warning signal is output.

18. The device of claim 17, wherein:
the processing unit includes a first module for determining the driver status and a second module for determining the lane change intention, information being exchanged between the two modules,
the second module for determining the lane change intention receiving information on at least one of the driver status and a driver vigilance from the first module for determining the driver status, and the first module for determining the driver status receiving information on at least one of a frequency of unintentional lane changes and a frequency at which thresholds of at least one variable are exceeded, from the second module for determining the lane change intention.

19. The device of claim 18, wherein the at least one variable includes at least one of a lateral distance to a lane edge marking and a time until a crossing of a lane marking.
